(19) United States
(12) Patent Application Publication
(10) Pub. No.: US 2026/0086512 A1
(43) Pub. Date: Mar. 26, 2026

(54) INTELLIGENT TEMPERATURE CONTROL METHOD FOR CASTING SYSTEM

(71) Applicant: CITIC Dicastal Co., Ltd., Qinhuangdao (CN)

(72) Inventors: Ji Wang, Qinhuangdao (CN); Xuewen Qian, Qinhuangdao (CN); Yiming Li, Qinhuangdao (CN); Tianxiao Yuan, Qinhuangdao (CN); Shiwei Guo, Qinhuangdao (CN); Dongxu Wen, Qinhuangdao (CN); Kaishun Wu, Qinhuangdao (CN); Zhihua Zhu, Qinhuangdao (CN); Shiwen Xu, Qinhuangdao (CN); Yajun Yin, Qinhuangdao (CN); Hongfeng Cui, Qinhuangdao (CN); Jianjun Li, Qinhuangdao (CN); Zhizhen Zheng, Qinhuangdao (CN)

(21) Appl. No.: 19/312,169

(22) Filed: Aug. 27, 2025

(30) Foreign Application Priority Data
Sep. 25, 2024 (CN) 202411345882.5

(51) Int. Cl. G05B 13/04; B22D 18/04; G05B 13/02

(52) U.S. Cl. CPC G05B 13/041; B22D 18/04; G05B 13/0265

(57) ABSTRACT

The present disclosure provides an intelligent temperature control method for a casting system, including: obtaining feature regions of a casting mold and arranging thermocouples in the feature regions of the mold based on structural characteristics of castings; building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and screening the thermocouples; and analyzing temperature data of screened thermocouple temperature measurement points, cooling process parameters, and corresponding casting quality, constructing a relation among the cooling process parameters, an initial temperature of each thermocouple in the mold, and the casting quality through a gradient boosting decision tree model, and controlling the temperature of the casting system based on the relation.

### TECHNICAL FIELD

The present disclosure belongs to the technical field of low-pressure casting processes, and particularly relates to an intelligent temperature control method for a casting system.

### BACKGROUND

Light-weighting is one of the important strategies for energy conservation and emission reduction in fuel vehicles and efficiency improvement in new energy vehicles. Among them, the replacement of conventional steel materials with aluminum alloy materials is a key means to achieve automobile light-weighting. A low-pressure casting process has become the mainstream process for producing automobile aluminum alloy castings due to its stable filling, good feeding effect, and high automation. In the low-pressure casting process, the influence of mold temperature on the quality of castings is particularly significant. During filling and solidification, an alloy melt, which is in direct contact with a mold, cools and solidifies through heat exchange. Therefore, the temperature distribution of the mold directly determines the solidification sequence and cooling rate of the alloy melt, which has a crucial impact on the solidification structures and properties of castings. Mold temperature is controlled within a reasonable range through an appropriate cooling process, which can ensure that the alloy solidifies rapidly in an expected sequence, thereby significantly reducing casting defects such as shrinkage cavities and shrinkage porosity, shortening a production cycle, and achieving dual improvement on casting quality and production efficiency.

At present, in low-pressure casting production of aluminum alloy castings, temperature control on a mold mainly adopts open-loop control mode. Usually, mold temperature is not detected and monitored in real time, but relies on on-site technicians to directly adjust cooling process parameters based on casting defects. Although this method is easy to operate, it has the following obvious shortcomings: the adjustment of the cooling process is greatly influenced by technicians' experience and subjective judgment, lacking scientific basis, which leads to unstable process improvement effects and makes it difficult to achieve automatic and intelligent control on mold temperature. With the advancement of automobile light-weighting and the increasing complexity of casting structures, reasonable control on mold temperature faces greater challenges. Conventional temperature control methods have become difficult to meet the requirements of modern production.

Temperature measurement and control of low-pressure casting aluminum alloy hub molds are key tasks in the manufacturing field, involving: obtaining and analyzing temperature data from an operating status of a mold to achieve precise temperature control. Effective temperature measurement and control methods can help manufacturing enterprises reduce production costs, improve product quality, and improve production efficiency. During low-pressure casting, the temperature of the mold has a direct impact on the molding quality and production stability of aluminum alloy wheels. Therefore, accurate temperature measurement and timely temperature adjustment are particularly important. Existing temperature control methods have the problems of poor accuracy and untimely temperature adjustment.

### SUMMARY

In view of the problems existing in the prior art, the present disclosure provides an intelligent temperature control method for a casting system, which at least partially solves the problems of poor accuracy and untimely temperature adjustment existing in the prior art.

An embodiment of the present disclosure provides an intelligent temperature control method for a casting system, including:
obtaining feature regions of a casting mold and arranging thermocouples in the feature regions of the mold based on structural characteristics of castings;
building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples; and
analyzing temperature data of screened thermocouple temperature measurement points, cooling process parameters, and corresponding casting quality, constructing a relation among the cooling process parameters, an initial temperature of each thermocouple in the mold, and the casting quality through a gradient boosting decision tree model, and controlling the temperature of the casting system based on the constructed relation.

Optionally, the obtaining feature regions of a casting mold includes:
collecting historical process data of the castings and the casting mold, and determining the feature regions of the casting mold based on X-ray inspection and simulated casting shrinkage cavity and porosity volume results from the historical process data.

Optionally, the collecting historical process data of the castings and the casting mold includes: collecting cooling process scheme data and casting quality data;

where the cooling process scheme data includes configuration and opening and closing time of cooling channels and/or a flow rate of a coolant in each production stage;

where the casting quality data includes casting quality indicators, including defect types, defect positions, and yield strength and/or tensile strength in the feature regions.

Optionally, the building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples, includes:
performing sensitivity test on the mold to select temperature data that meets mold closing time as independent variables and the casting quality as a dependent variable for calculation, building the random forest model, calculating importance of each feature, and selecting, based on the importance of the features, thermocouples reflecting the casting quality as standard thermocouples at a top mold, a bottom mold, and side molds of the mold respectively.

Optionally, the building a random forest model and performing recursive feature elimination based on temperature measurement results of the thermocouples and casting quality inspection results includes:
step 1: training the random forest model by using the obtained features and calculating a weight or coefficient of each feature in the random forest model;
step 2: sorting the features based on the weights or coefficients of the features;
step 3: deleting one or more features with the minimum weight or coefficient from the sorted features, and retraining the random forest model with the remaining features; and
step 4: repeating steps 2 and 3 until a required quantity of features is reached or no features are deleted.

Optionally, calculating temperature feature importance of the thermocouples includes:
calculating Gini impurities of nodes;
calculating a contribution of each feature;
accumulating the contributions of the features; and
calculating feature importance of all trees in the random forest, and averaging feature importance values of all the trees to obtain final importance of the features.

Optionally, the analyzing temperature data from screened thermocouple temperature measurement points, cooling process parameters, and corresponding casting quantity, constructing a relation among the cooling process parameters, an initial temperature of each thermocouple in the mold, and the casting quality through a gradient boosting decision tree model, and controlling the temperature of the casting system based on the constructed relation, includes:
obtaining a parameter data set of the temperature data of the screened thermocouple temperature measurement points, the cooling process parameters, and the corresponding casting quality;
under the condition of ensuring qualified castings, outputting a relational model between an initial temperature of the feature regions of the mold and a cooling process based on the parameter dataset to predict the strength of a hub;
iteratively optimizing the relational model based on the difference between the quality and strength of the castings and actual values; and
evaluating the relational model based on a mean square error and a determination coefficient, and stopping the iterative optimization when the prediction success rate is greater than a set value.

Optionally, the cooling process scheme data and the casting quality data are used to train the gradient boosting decision tree model and dynamically update the mold cooling process scheme and control rules; and
the gradient boosting decision tree model is used to predict the cooling process scheme that conforms to inspection criteria.

Optionally, the learning rate of the gradient boosting decision tree model is 0.01 to 0.3.

Optionally, the tree depth of the gradient boosting decision tree model is 3 to 10.

By arranging the thermocouples and based on the random forest model and the gradient boosting decision tree model, the intelligent temperature control method for the casting system, provided by the present disclosure, improves the accuracy of temperature control and adjusts the temperature in a timely manner, thereby achieving the purposes of optimizing the casting process, reducing defects, and ensuring high-quality manufacturing of aluminum alloy hubs.

### BRIEF DESCRIPTION OF THE DRAWINGS

The above and other objectives, features and advantages of the present disclosure will become more apparent from more detailed descriptions of exemplary embodiments of the present disclosure with reference to the accompanying drawings. Like reference numerals in the exemplary embodiments of the present disclosure generally refer to the same components.

FIG. 1 is a schematic flowchart of an intelligent temperature control technology for a casting system according to an embodiment of the present disclosure;

FIG. 2 is a schematic diagram of temperature measurement positions of mold thermocouples and specific positions of cooling channels and heating channels on a mold according to an embodiment of the present disclosure;

FIG. 3 is a schematic diagram of ranking of thermocouple weight coefficients and feature importance based on a random forest according to an embodiment of the present disclosure;

FIG. 4 is a schematic diagram of a method for building a gradient boosting decision tree model according to an embodiment of the present disclosure;

FIG. 5 is a schematic diagram of mold temperature measurement results of actually produced castings after the application of optimized process parameters according to an embodiment of the present disclosure; and

FIG. 6A and FIG. 6B are X-ray inspection images of a wheel center of actually produced castings after the application of optimized process parameters according to an embodiment of the present disclosure.

### DETAILED DESCRIPTION

Embodiments of the present disclosure will be described in detail below with reference to the accompanying drawings.

For ease of understanding, an embodiment discloses an intelligent temperature control method for a casting system, including:
obtaining feature regions of a casting mold and arranging thermocouples in the feature regions of the mold based on structural characteristics of castings;
building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples; and
analyzing temperature data of screened thermocouple temperature measurement points, cooling process parameters, and corresponding casting quality, constructing a relation among the cooling process parameters, an initial temperature of each thermocouple in the mold, and the casting quality through a gradient boosting decision tree model, and controlling the temperature of the casting system based on the constructed relation.

Optionally, the obtaining feature regions of a casting mold includes:
collecting historical process data of the castings and the casting mold, and determining the feature regions of the casting mold based on X-ray inspection and simulated casting shrinkage cavity and porosity volume results from the historical process data.

Optionally, the collecting historical process data of the castings and the casting mold includes: collecting cooling process scheme data and casting quality data;
where the cooling process scheme data include configuration and opening and closing time of cooling channels and/or a flow rate of a coolant in each production stage;
where the casting quality data comprises casting quality indicators, comprising defect types, defect positions, and yield strength and/or tensile strength in the feature regions.

Optionally, the building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples, includes:
performing sensitivity test on the mold to select temperature data that meets mold closing time as independent variables and the casting quality as a dependent variable for calculation, building the random forest model, calculating importance of each feature, and selecting, based on the importance of the features, thermocouples reflecting the casting quality as standard thermocouples at a top mold, a bottom mold, and side molds of the mold respectively.

Optionally, the building a random forest model and performing recursive feature elimination based on temperature measurement results of the thermocouples and casting quality inspection results includes:
step 1: training the random forest model by using the obtained features and calculating a weight or coefficient of each feature in the random forest model;
step 2: sorting the features based on the weights or coefficients of the features;
step 3: deleting one or more features with the minimum weight or coefficient from the sorted features, and retraining the random forest model with the remaining features; and
step 4: repeating steps 2 and 3 until a required quantity of features is reached or no features are deleted.

Optionally, calculating temperature feature importance of the thermocouples includes:
calculating Gini impurities of nodes;
calculating a contribution of each feature;
accumulating the contributions of the features; and
calculating feature importance of all trees in the random forest, and averaging feature importance values of all the trees to obtain final importance of the features.

Optionally, the analyzing temperature data from screened thermocouple temperature measurement points, cooling process parameters, and corresponding casting quantity, constructing a relation among the cooling process parameters, an initial temperature of each thermocouple in the mold, and the casting quality through a gradient boosting decision tree model, and controlling the temperature of the casting system based on the constructed relation, includes:
obtaining a parameter data set of the temperature data of the screened thermocouple temperature measurement points, the cooling process parameters, and the corresponding casting quality;
under the condition of ensuring qualified castings, outputting a relational model between an initial temperature of the feature regions of the mold and a cooling process based on the parameter dataset to predict the strength of a hub; and
iteratively optimizing the relational model based on the difference between the quality and strength of the castings and actual values.

The iteratively optimizing the relational model based on the difference between the quality and strength of the castings and actual values includes: firstly, calculating a maximum deviation Emax and an average deviation Eavg between a target value of casting quality inspection and an actual inspection value under current cooling process conditions; then, determining a residual value based on these deviations and calculating an opening time adjustment value topenm and a closing time adjustment value tclosem of the cooling channels through the residual value; modifying the cooling process scheme based on these adjustment values to obtain new cooling process settings; repeating this optimization process until the actual quality inspection value of the casting completely falls within a target range and the deviation from the target value is reduced to a preset range, and then stopping the optimization; and
evaluating the relational model based on a mean square error and a determination coefficient, and stopping the iterative optimization when the prediction success rate is greater than a set value, where the set value is 90%.

Optionally, the cooling process scheme data and the casting quality data are used to train the gradient boosting decision tree model and dynamically update the mold cooling process scheme and control rules; and
the gradient boosting decision tree model is used to predict the cooling process scheme that conforms to inspection criteria.

Optionally, the learning rate of the gradient boosting decision tree model is 0.01 to 0.3.

Optionally, the tree depth of the gradient boosting decision tree model is 3 to 10.

In a specific application scenario, taking a hub as an example:
Step one: Determine feature regions of a mold and arrange thermocouples.

First, historical process data of a target product and the mold need to be collected. These data include numerical simulation results and trial production results. The feature regions of the casting mold are determined based on X-ray inspection and simulated hub shrinkage cavity and porosity volume results.

Next, a detailed database is built based on the collected process data. The database should include an entire production process of each product, covering the following key contents:

Cooling process scheme data: Record detailed information such as configuration and opening and closing time of cooling channels and a flow rate of a coolant in each production stage.

Casting quality data: Record corresponding casting quality indicators, such as defect types, defect positions, and yield strength and tensile strength in the feature regions.

Each database record corresponds to a production process of a specific product. By systematically organizing and storing these data, a reliable basis can be provided for subsequent process optimization and model training.
Step two: Build a thermocouple weight coefficient model and optimize the quantity.

Perform sensitivity test on the mold: Select a set of standard cooling process as a reference. During continuous production, the standard cooling process is adopted for the first 3 hubs to ensure that the mold is at a normal temperature and the casting quality is good. For the last 5 hubs, one cooling channel is closed in the standard cooling process for testing. This process is repeated to close each cooling channel until the test is completed. Data collected from the thermocouples are processed. Temperature data at the 1st second and the 100th second of the mold closing time are selected as independent variables, and a hub mass is selected as a dependent variable for calculation. A random forest model is built in python and the importance of each feature is calculated. According to the importance of the features, one thermocouple reflecting the casting quality is selected from each of three major parts of the mold: a top mold, a bottom mold, and side molds, as standard thermocouples for subsequent calculation and analysis. The process is as follows.
Step 1: Initialization: First, train a model with all available features and calculate a weight or coefficient of each feature.
Step 2: Feature sorting: Then, sort the features based on the weights or coefficients of the features. Generally, the features with the minimum weight or coefficient are considered the least important.
Step 3: Feature deletion: Next, delete one or more features with the minimum weight or coefficient from the sorted features, and retrain the model with the remaining features.
Step 4: Iterative process: Repeat steps 2 and 3 until a required quantity of features is reached or no features are deleted.

A temperature feature importance of each thermocouple is calculated as follows:

### 1. Train a Random Forest Model

Build a random forest: The random forest is an integrated model composed of a plurality of decision trees. A subset (subset of samples and features) is randomly selected from original data, and then each decision tree is trained on the subset.

### 2. Calculate Gini Importance

The Gini importance measures a contribution of each feature in term of reducing model impurity (Gini impurity).

Calculate Gini impurities of nodes: Calculate a Gini impurity Gj of each node j;

$${G}_{j} = 1 - {\sum }_{k = 1}^{k} {p}_{jk}^{2} ,$$

where pjk represents a probability of a kth category in node j, and k represents a quantity of categories.

Calculate a contribution of each feature: the contribution of feature i on node j is:

$$△ {G}_{ij} = {G}_{parent} - ( \frac{{N}_{left}}{{N}_{parent}} \cdot {G}_{left} + \frac{{N}_{right}}{{N}_{parent}} \cdot {G}_{right} ) ,$$

where Gparent represents a Gini impurity of a parent node, Gleft and Gright represent Gini impurities of a left child node and a right child node respectively, Nparent represents a sample size of the parent node, Nleft and Nright represent sample sizes of the left child node and the right child node respectively.

Accumulate the contributions of the features: for each tree t, the importance Ii(t) of feature i is a sum of the contributions of all nodes:

$${I}_{i} ( t ) = {\sum }_{j ∈ nodes} △ {G}_{ij} ,$$

Calculate feature importance of all trees in the random forest: average feature importance values of all the trees to obtain final importance of the feature i:

$$Feature {Importance}_{i} = \frac{1}{T} {\sum }_{t = 1}^{T} {I}_{i} ( t ) ,$$

where T represents a quantity of the trees.
Step three: Build a cooling process, initial mold temperature and casting quality model.

After thermocouple positions are screened, analysis is performed based on temperature data from screened thermocouple temperature measurement points, cooling process parameters, and corresponding casting quantity, and a relation among the cooling process parameters, an initial temperature of each thermocouple in the mold, and the casting quality is constructed through a gradient boosting decision tree model, specifically as follows:

The temperature data extracted from each thermocouple temperature measurement point at the 1st second of mold closing is Tstarti, where i represents a different position, sequentially arranged according to the feature importance of the thermocouple. The flow rate is 80 m³/h in air cooling channels and 5 L/min in water cooling channels. The opening time of the cooling channels is topenj, and the closing time is tclosej, where j represents a different cooling channel. Parameter code corresponding to each casting is:

$$x = ( Tstart 1 , Tpeak 1 , … , Tstart n , Tpeakn , topen 1 , tclose 1 , … , topenm , tclose m , )$$

$$y = ( q 1 , q 2 , q 3 , … , qn , Rm 1 , … , Rmn , Q 1 , … , Qn , )$$

where y represents casting quality inspection. qi represents whether the ith type of 3 defects occurs, denoted by 0 and 1, 0 represents no defect, 1 represents the occurrence of defect, Rm1 represents tensile strength test results of a hub in a first feature region, Q1 represents yield strength test results of the hub in the first feature region, and the feature region includes an outer flange, an inner flange, spokes, a core, and a rim of the hub, as well as finite element simulation results.

Under the condition of ensuring qualified castings, a relational model between an initial temperature of the feature regions of the mold and a cooling process is output to predict the strength of a hub.

The model is iteratively optimized based on the difference between the quality and strength of the castings and actual values: Firstly, a maximum deviation Emax and an average deviation Eavg between a target value of casting quality inspection and an actual inspection value under current cooling process conditions. Then, a residual value is determined based on these deviations, and an opening time adjustment value topenm and a closing time adjustment value tclosem of the cooling channels are calculated through the residual value. The cooling process scheme is modified based on these adjustment values to obtain new cooling process settings. This optimization process is repeated until the actual quality inspection value of the casting completely falls within a target range and the deviation from the target value is reduced to a preset range, and then the optimization is stopped.

The model is iterated based on the residual, and the model is evaluated based on a mean square error and a determination coefficient. The model can be used when the prediction success rate is greater than 90%.

In step one, the database used for model training at least contains group trial production data; and at least 10 groups of cooling process schemes are predicted and output through the gradient boosting decision tree model for on-site production verification.

In step one, a cooling process scheme that conforms to inspection criteria is predicted by using the GBDT (gradient boosting decision tree) model and verified on site. For example, in accordance with the ASTME155 standard, the cooling process scheme corresponding to castings below defect level two is selected for on-site production testing.

The newly obtained on-site verification data (including the cooling process scheme and casting quality) in step one is added to the database for training the GBDT model and dynamically updating the mold cooling process scheme and control rules.

In step one, the top mold, bottom mold, and side molds of the mold are all measured by the thermocouples that are arranged at different positions.

In step one, at least 90% of the data in the built database is used as a training set for model training, and the remaining data is used as a test set for evaluating model prediction performance.

In step three, the learning rate (learning_rate) of the gradient boosting decision tree (GBDT) model ranges from 0.01 to 0.3. The tree depth (max_depth) ranges from 3 to 10.

In step three, after the casting quality defect prediction model is built, when the accuracy rate of the model on the test set reaches or exceeds a set value, this model is used to predict the cooling process scheme and carry out on-site production verification.

In step two, the sorting of feature importance is based on the criteria of different regions of the mold, and the arrangement of thermocouples at different positions of the top mold, bottom mold, and side molds of the mold.

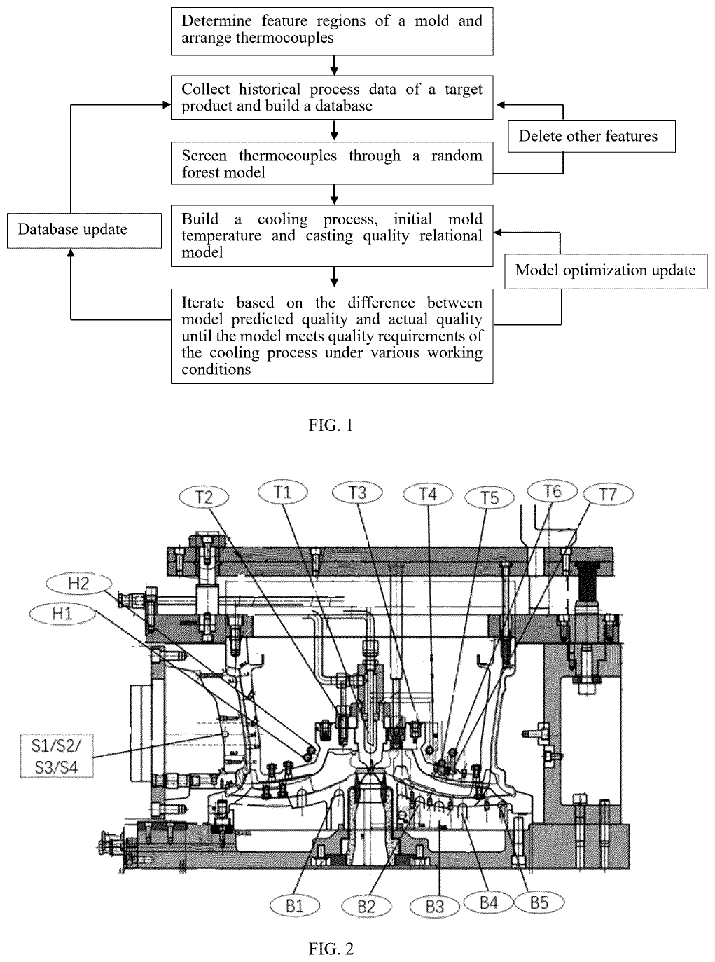

Specifically as shown in FIG. 1, the process is as follows:

Step 101: Determine mold feature regions.

Taking a low-pressure casting mold for a certain hub as an example, 100 trial-produced hubs are inspected by X-ray, showing shrinkage cavity and porosity defects at outer flanges, junctions of spokes and outer flanges, and wheel centers, where the defect positions of the hubs correspond to the mold feature regions.

As shown in FIG. 2 and Table 1, thermocouples are arranged on the mold based on the above mold feature regions: ten thermocouples are arranged on the top mold, respectively at an ejector rod opening of the mold, beside a T4 cooling channel, near the outer side of the inner flange, on the inner side of the inner flange of the top mold, at the edge of the top mold, on the inner side of the top mold rim, on the inner side of the top mold rim, on the outer side of the top mold rim, on the outer side of the top mold rim, and at an ejector rod opening of the inner flange. The side mold consists of four side molds, marked with numbers 1, 2, 3, and 4. Thermocouples are respectively arranged on each side mold at the inner flange, near the outer flange, and at the rim, totaling 12 thermocouples, and one thermocouple is arranged on inner and outer sides of the 1 #side mold. 6 thermocouples are arranged on the bottom mold, respectively beside B1, between B2 and B3, between B2 and B3, beside B3, between B4 and B5, and between B4 and B5 of the bottom mold. 16 cooling channels and two heating channels are arranged in the mold. Among them, the cooling channels B1, B2, B3, B4, and B5 are arranged in the bottom mold, the cooling medium therein is an air cooling medium with a flow rate of 80 m³/h, and according to the numbers, B1 is arranged closest to the wheel center and B5 is arranged on the outer side of the bottom mold. The cooling channels T1, T2, T3, T4, T5, T6, and T7 are arranged in the top mold, the cooling medium therein is an air cooling medium with a flow rate of 80 m³/h, and according to the numbers, T1 is closest to the ejector rod opening and T7 is close to the outer side of the top mold. One cooling channel is arranged in each of the four side molds, the cooling medium therein is a water cooling medium with a flow rate of 5 L/mi, the numbers S1, S2, S3, and S4 correspond to the numbers of the side molds, and the cooling channel is arranged in the side mold close to the outer flange. The two heating channels are arranged in the top mold near the wheel center, numbered H1 and H2. Heating resistance wires therein are made of nickel-chromium alloy, with a diameter of 0.5 mm.

TABLE 1
Arrangement positions of thermocouples

| Code of | | Code of temperature | |
|---|---|---|---|
| mold | Position of | collection | |
| cooling | cooling | position of | Mold temperature |
| pipeline | channel | die-casting machine | collection position |
| B5 | (Bottom mold | TC1 | Ejector rod opening |
| | air cooling) | | |
| B4 | (Bottom mold | TC2 | Outside T4 |
| | air cooling) | | |
| B3 | (Bottom mold | TC3 | Top mold (inner side |
| | air cooling) | | of the flange) |
| B2 | (Bottom mold | TC4 | Top mold (outer side |
| | air cooling) | | of the flange) |
| B1 | (Bottom mold | TC5 | Top mold edge |
| | air cooling) | | |
| T1 | (Top mold | TC6 | Upper on the inner |
| | air cooling) | | side of top mold rim |
| T2 | (Top mold | TC7 | Lower on the inner |
| | air cooling) | | side of top mold rim |
| T3 | (Top mold | TC8 | Upper on the inner |
| | air cooling) | | side of top mold rim |
| T4 | (Top mold | TC9 | Lower on the inner |
| | air cooling) | | side of top mold rim |
| T5 | (Top mold | TC10 | Inner flange ejector |
| | air cooling) | | rod opening |
| T6 | (Top mold | TC11 | Beside bottom mold |
| | air cooling) | | B1 |
| T7 | (Top mold | TC12 | Between bottom mold |
| | air cooling) | | B2 and B3 |
| S1 | (Side mold | TC13 | Between bottom mold |
| | water cooling) | | B2 and B3 |
| S2 | (Side mold | TC14 | Beside bottom mold |
| | water cooling) | | B3 |
| S3 | (Side mold | TC15 | Between bottom mold |
| | water cooling) | | B4 and B5 |
| S4 | (Side mold | TC16 | Between bottom mold |
| | water cooling) | | B4 and B5 |
| H1 | (Top mold | TC17 | Inner flange of 1# |
| | heating) | | side mold |
| H2 | (Top mold | TC18 | Rim of 1# side mold |
| | heating) | | |
| | | TC19 | Outer flange of 1# |
| | | | side mold |
| | | TC20 | Inner flange of 2# |
| | | | side mold |
| | | TC21 | Rim of 2# side mold |
| | | TC22 | Outer flange of 2# |
| | | | side mold |
| | | TC23 | Inner flange of 3# |
| | | | side mold |
| | | TC24 | Rim of 3# side mold |
| | | TC25 | Outer flange of 3# |
| | | | side mold |
| | | TC26 | Inner flange of 4# |
| | | | side mold |
| | | TC27 | Rim of 4# side mold |
| | | TC28 | Outer flange of 4# |
| | | | side mold |
| | | TC29 | Outer side of 1# side |
| | | | mold |
| | | TC30 | Inner side of 1# side |
| | | | mold |

Step 102: Build a thermocouple weight coefficient model and optimize the quantity.

Perform sensitivity test on castings: Firstly, a set of standard cooling process is selected as a benchmark, and this standard process is applied to the first three hubs to ensure normal mold temperature and obtain good casting quality. Subsequently, the last five hubs are tested, with one cooling channel closed each time. Temperature data at the 1st second and 100th second of the mold closing time are recorded. These data are used as independent variables and the hub mass is used as a dependent variable to analyze the importance of each feature through a random forest model in Python. Based on the analysis results, one key thermocouple is selected from each of the top mold, bottom mold and side molds to reflect the casting quality and conduct subsequent analysis. Thermocouple temperature measurement points with importance greater than 90% are selected for subsequent data analysis.

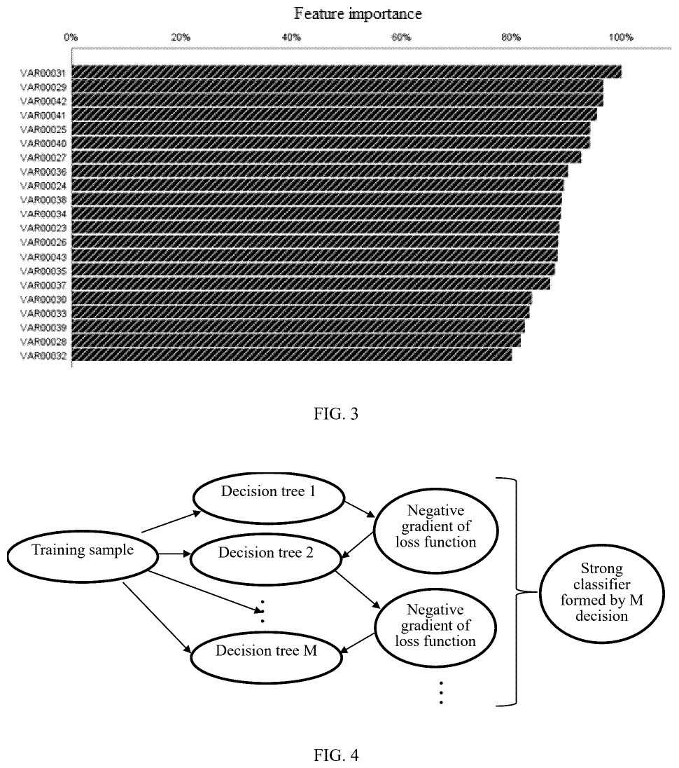

Table 2, FIG. 3, and Table 3 show the following.

TABLE 2
Specific parameters of the random forest model

| Condition of the random forest model | Parameter |
|---|---|
| Quantity of trees | 100 to 1000 |
| Quantity of features considered for each tree | ‘sqrt’ |
| Minimum sample size required for further | 2 to 10 |
| division of internal nodes | |
| Quantity of features removed in each recursion | 1 |
| Split mass | ‘gini’ |
| Minimum sample size required for leaf nodes | 1-10 |
| Indicators for evaluating model performance | ‘precision’ |

TABLE 3
Codes and specific positions of thermocouple temperature
measurement positions after optimization

| Optimized | Thermocouple temperature |
|---|---|
| thermocouple code | measurement position |
| TC1 | Ejector rod opening |
| TC2 | Outside T4 |
| TC7 | Lower on the inner side of 1# side mold rim |
| TC12 | Between bottom mold B2 and B3 |
| TC14 | Beside bottom mold B3 |
| TC17 | Inner flange of 1# side mold |
| TC18 | Rim of 1# side mold |
| TC24 | Rim of 3# side mold |
| TC25 | Outer flange of 3# side mold |
| TC26 | Inner flange of 4# side mold |
| TC27 | Rim of 4# side mold |

Step 103: Build a cooling process, initial mold temperature and casting quality model

FIG. 4 shows a method for building a gradient boosting decision tree model.

Process simulation and actual trial production data are collected to build a database, including cooling process data of 16 cooling channels, temperature data of 10 mold temperature measurement points, and mechanical properties of feature regions of corresponding castings. Each data record covers the entire production process of a product. The cooling process and mold temperature data are collected in steps of 1 second, where the statuses of the cooling channels are indicated by 1 (open) or 0 (closed). The database contains at least 100 pieces of data.

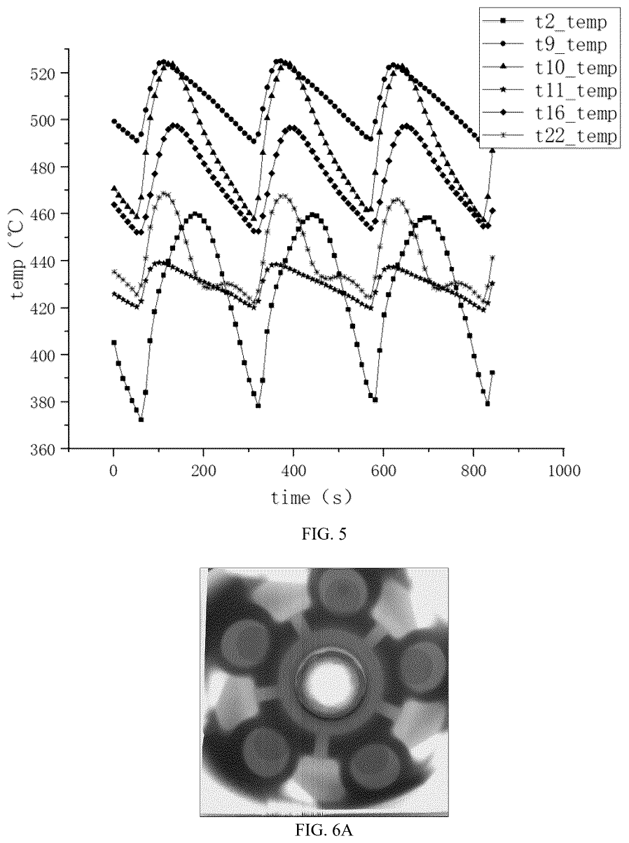

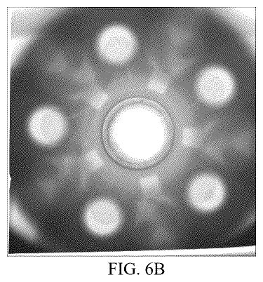

Based on the database built in step one, a prediction model of a cooling process scheme is built by using a gradient boosting decision tree (GBDT) method. Firstly, 90% of the data in the database is used for model training, and the remaining 10% is used for performance evaluation. A gradient boosting decision tree model is built based on the temperature measurement data of 10 thermocouples, the cooling process, and the casting quality. The settings of initial model training include: a learning rate of 0.1, 100 trees, a maximum depth of 3, and use of GBDT for training. During training, the learning rate, the quantity of trees, and the maximum depth are continuously adjusted until the average prediction accuracy of the model on the test set reaches or exceeds 90%. In this embodiment, the final average prediction accuracy of the model on the test set is 90.3%. Cooling process parameters at different mold temperatures are output based on the model. The process optimization is as shown in Table 4: This process was used for trial production, and no defective products were produced during 2-hour continuous trial production. The temperature data of some hub molds are shown in FIG. 5 below, where the temperature remains stable, and the difference between maximum and minimum temperatures at the same time does not exceed 5° C. As shown in FIG. 6A and FIG. 6B, X-ray inspection comparison before and after wheel center process optimization shows that there is a certain degree of shrinkage porosity and shrinkage cavities before optimization. The comparison of mechanical properties in the feature regions of the hub before and after process optimization shows that the performance at each position of the hub is improved, as shown in Table 5. FIG. 6 shows the comparison of occurrence of defects in the feature regions of actually produced castings before and after the application of optimized process parameters, indicating that the occurrence of defects in the feature regions of the hub is significantly improved after the application of optimized process parameters.

TABLE 4
Process optimization table

| | Initial | Code of | Initial | Initial | Optimized | Optimized |
|---|---|---|---|---|---|---|
| Mold | temperature | cooling | opening | closing | opening | closing |
| code | (° C.) | channel | time (s) | time (s) | time (s) | time (s) |
| TC1 | 390.1 | B5 | 20 | 180 | 25 | 173 |
| TC2 | 500.3 | B4 | 50 | 130 | 42 | 150 |
| TC7 | 496.1 | B3 | 50 | 170 | 50 | 175 |
| TC12 | 472.8 | B2 | 60 | 180 | 63 | 175 |
| TC14 | 482.2 | B1 | 80 | 180 | 75 | 170 |
| TC17 | 417.8 | T1 | 110 | 180 | 104 | 176 |
| TC18 | 420.3 | T2 | 80 | 190 | 72 | 179 |
| TC24 | 463.2 | T3 | 100 | 180 | 100 | 180 |
| TC25 | 420.8 | T4 | 80 | 180 | 82 | 173 |
| TC26 | 414.6 | T5 | 60 | 160 | 56 | 164 |
| TC27 | 457.6 | T6 | 80 | 180 | 76 | 170 |
| | | T7 | 10 | 160 | 10 | 135 |
| | | S1 | 20 | 120 | 15 | 135 |
| | | S2 | 20 | 120 | 15 | 135 |
| | | S3 | 20 | 120 | 15 | 135 |
| | | S4 | 20 | 120 | 15 | 135 |

TABLE 5
Comparison of mechanical properties in feature regions of the hub
before and after and performance at each position of the hub

| Hub feature | Initial yield | Initial tensile | Optimized yield | Optimized tensile |
|---|---|---|---|---|
| region | strength (MPa) | strength (MPa) | strength (MPa) | strength (MPa) |
| Outer flange | 173 | 269 | 185 | 278 |
| Inner flange | 178 | 274 | 191 | 296 |
| Spokes | 161 | 240 | 175 | 253 |
| Wheel center | 168 | 260 | 179 | 276 |
| Rim | 171 | 265 | 181 | 286 |

TABLE 6
Comparison of occurrence of defects in feature regions
of actually produced castings before and after the
application of optimized process parameters

| | Initial process | Optimized process |
|---|---|---|
| Defect in feature region | instance | instance |
| Spoke shrinkage cavity | Many | Rare |
| Rim shrinkage porosity | High | Rare |
| Wheel center pore | Many | None |
| Excessive pinhole | Rare | None |
| Insufficient casting | Rare | None |

The control method disclosed in the embodiments has the following advantages:
1. On-site production data is combined with simulation to determine mold feature regions based on hub defects under X-ray inspection, thermocouples are arranged in the mold feature regions according to the structural characteristics of a hub to measure the temperature, a random forest model is built based on the temperature measurement results and casting quality inspection, recursive feature elimination is performed, a correlation between the temperature measurement data of each thermocouple and the hub quality is determined, the quantity of thermocouples is optimized, and thermocouple temperature measurement positions corresponding to various defects of castings are sought.
2. A gradient boosting decision tree model is built based on cooling process parameters, mold temperature, casting quality and feature region performance, and the casting quality is determined based on the cooling process and mold temperature. Compared with manual control, the control method can detect whether castings have defects during production, and then make adjustments, such as change cooling parameters and control mold temperature, thereby achieving automation and intelligence.
3. The casting quality is predicted based on a mold temperature range, and delay in conventional cooling processes is abandoned. When defects occur in castings, on-site workers change cooling parameters based on their experience, which cannot improve the mold temperature in a short time. The control based on the mold temperature range can determine the start and stop time of the cooling process based on the temperature of thermocouples in the production process of each casting, and control the temperature within a reasonable range to ensure the quality of castings.

1. An intelligent temperature control method for a casting system, comprising:
obtaining feature regions of a casting mold and arranging thermocouples in the feature regions of the mold based on structural characteristics of castings;
building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples; and
analyzing temperature data of screened thermocouple temperature measurement points, cooling process parameters, and corresponding casting quality, constructing a relation among the cooling process parameters, an initial temperature of each thermocouple in the mold, and the casting quality through a gradient boosting decision tree model, and controlling the temperature of the casting system based on the constructed relation.

2. The intelligent temperature control method for the casting system according to claim 1, wherein the obtaining feature regions of a casting mold comprises:
collecting historical process data of the castings and the casting mold, and determining the feature regions of the casting mold based on X-ray inspection and simulated casting shrinkage cavity and porosity volume results from the historical process data.

3. The intelligent temperature control method for the casting system according to claim 2, wherein the collecting historical process data of the castings and the casting mold comprises: collecting cooling process scheme data and casting quality data;
wherein the cooling process scheme data comprises configuration and opening and closing time of cooling channels and/or a flow rate of a coolant in each production stage;
wherein the casting quality data comprises casting quality indicators, comprising defect types, defect positions, and yield strength and/or tensile strength in the feature regions.

4. The intelligent temperature control method for the casting system according to claim 1, wherein the building a random forest model and performing recursive feature elimination based on temperature measurement results of the thermocouples and casting quality inspection results, to determine a correlation between temperature measurement data of each thermocouple and casting quality, thereby optimizing a quantity of the thermocouples and obtaining temperature measurement positions of the thermocouples corresponding to various defects of the castings, so as to screen the thermocouples, comprises:
performing sensitivity test on the mold to select temperature data that meets mold closing time as independent variables and the casting quality as a dependent variable for calculation, building the random forest model, calculating importance of each feature, and selecting, based on the importance of the features, thermocouples reflecting the casting quality as standard thermocouples at a top mold, a bottom mold, and side molds of the mold respectively.

5. The intelligent temperature control method for the casting system according to claim 4, wherein the building a random forest model and performing recursive feature elimination based on temperature measurement results of the thermocouples and casting quality inspection results comprises:
step 1: training the random forest model by using the obtained features and calculating a weight or coefficient of each feature in the random forest model;
step 2: sorting the features based on the weights or coefficients of the features;
step 3: deleting one or more features with the minimum weight or coefficient from the sorted features, and retraining the random forest model with the remaining features; and
step 4: repeating steps 2 and 3 until a required quantity of features is reached or no features are deleted.

6. The intelligent temperature control method for the casting system according to claim 5, wherein calculating temperature feature importance of the thermocouples comprises:
calculating Gini impurities of nodes;
calculating a contribution of each feature;
accumulating the contributions of the features; and
calculating feature importance of all trees in the random forest, and averaging feature importance values of all the trees to obtain final importance of the features.

7. The intelligent temperature control method for the casting system according to claim 1, wherein the analyzing temperature data of screened thermocouple temperature measurement points, cooling process parameters, and corresponding casting quality, constructing a relation among the cooling process parameters, an initial temperature of each thermocouple in the mold, and the casting quality through a gradient boosting decision tree model, and controlling the temperature of the casting system based on the constructed relation, comprises:
obtaining a parameter data set of the temperature data of the screened thermocouple temperature measurement points, the cooling process parameters, and the corresponding casting quality;
under the condition of ensuring qualified castings, outputting a relational model between an initial temperature of the feature regions of the mold and a cooling process based on the parameter dataset to predict the strength of a hub;
iteratively optimizing the relational model based on the difference between the quality and strength of the castings and actual values; and
evaluating the relational model based on a mean square error and a determination coefficient, and stopping the iterative optimization when the prediction success rate is greater than a set value.

8. The intelligent temperature control method for the casting system according to claim 3, wherein the cooling process scheme data and the casting quality data are used to train the gradient boosting decision tree model and dynamically update the mold cooling process scheme and control rules; and
the gradient boosting decision tree model is used to predict the cooling process scheme that conforms to inspection criteria.

9. The intelligent temperature control method for the casting system according to claim 8, wherein the learning rate of the gradient boosting decision tree model is 0.01 to 0.3.

10. The intelligent temperature control method for the casting system according to claim 9, wherein the tree depth of the gradient boosting decision tree model is 3 to 10.
